(19) United States
(12) Patent Application Publication
(10) Pub. No.: US 2025/0340718 A1
(43) Pub. Date: Nov. 6, 2025

(54) RESIN COMPOSITION FOR VEHICLE COOLANT TRANSPORT TUBE AND VEHICLE COOLANT TRANSPORT TUBE

(71) Applicant: Sumitomo Riko Company Limited, Aichi (JP)

(72) Inventors: Masashi OKAHISA, Aichi (JP); Koji MIZUTANI, Aichi (JP)

(73) Assignee: Sumitomo Riko Company Limited, Aichi (JP)

(21) Appl. No.: 19/263,424

(22) Filed: Jul. 8, 2025

Related U.S. Application Data
(63) Continuation of application No. PCT/JP2024/006487, filed on Feb. 22, 2024.

(30) Foreign Application Priority Data
Mar. 16, 2023 (JP) 2023-041770

(51) Int. Cl. C08K 5/00

(52) U.S. Cl. CPC C08K 5/005

(57) ABSTRACT

A resin composition for a vehicle coolant transport tube and a vehicle coolant transport tube are capable of high-temperature extrusion and excellent in heat resistance and inner surface smoothness. The resin composition for a vehicle coolant transport tube contains (A) and (B) below. The vehicle coolant transport tube is composed of the resin composition for a vehicle coolant transport tube. (A) A polypropylene-based resin having a melting point of 145° C. or higher and a melt flow rate of 0.2 g/10 min or more and 2.0 g/10 min or less measured at 230° C. under a load of 2.16 kg. (B) An antioxidant having a melting point of 100° C. or higher.

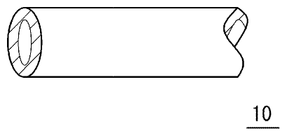

### CROSS-REFERENCE TO RELATED APPLICATION

The present application is a continuation of PCT/JP2024/006487, filed on Feb. 22, 2024, and is related to and claims priority from Japanese patent application no. 2023-041770, filed on Mar. 16, 2023. The entire contents of the aforementioned application are hereby incorporated by reference herein.

### BACKGROUND

### Technical Field

The disclosure relates to a resin composition for a vehicle coolant transport tube and a vehicle coolant transport tube, and more specifically to a resin composition for a vehicle coolant transport tube and a vehicle coolant transport tube suitable as a tube for transporting a coolant in a cooling system of an automobile and the like.

### Related Art

A coolant transport tube serves as a tube for transporting a coolant in a cooling system of a gasoline vehicle, an electric vehicle, etc. In a coolant transport tube, polyamide resin is often adopted from the viewpoint of heat resistance. In recent years, polypropylene-based resin, which is advantageous in terms of cost, has been considered to serve as a material of the coolant transport tube.

### RELATED ART DOCUMENTS

### Patent Documents

Patent Document 1: Japanese Patent Application Laid-Open No. 2012-091730
Patent Document 2: Japanese Patent Application Laid-Open No. 2006-194318

A coolant transport tube is long and has many corner parts in the piping. Thus, flow resistance is large. If smoothness of a tube inner surface is low, stress may be applied locally, and cracks may occur. Also, if an extrusion temperature of the tube is low, smoothness of the tube inner surface tends to decrease. On the other hand, if the extrusion temperature is increased, physical properties of the tube tend to deteriorate.

### SUMMARY

A resin composition for a vehicle coolant transport tube according to an embodiment of the disclosure contains (A) and (B) below:
(A) a polypropylene-based resin having a melting point of 145° C. or higher and a melt flow rate of 0.2 g/10 min or more and 2.0 g/10 min or less measured at 230° C. under a load of 2.16 kg; and
(B) an antioxidant having a melting point of 100° C. or higher.

The (B) may be an antioxidant that does not have an ester bond in a molecular skeleton. The (B) may have a molecular weight of 500 or more. The melting point of the (B) may be 150° C. or higher. The (B) may be included at a content of 0.05 parts by mass or more and 1.0 part by mass or less with respect to 100 parts by mass of the (A). The (B) may be a phenolic antioxidant. The (B) may be a hindered phenolic antioxidant. The (A) may be a propylene-α-olefin block copolymer.

Also, a vehicle coolant transport tube according to an embodiment of the disclosure is composed of the above resin composition for a vehicle coolant transport tube.
(1) A resin composition for a vehicle coolant transport tube according to an embodiment of the disclosure contains (A) and (B) below:
(A) a polypropylene-based resin having a melting point of 145° C. or higher and a melt flow rate of 0.2 g/10 min or more and 2.0 g/10 min or less measured at 230° C. under a load of 2.16 kg; and
(B) an antioxidant having a melting point of 100° C. or higher.
(2) In (1) above, the (B) may be an antioxidant that does not have an ester bond in a molecular skeleton.
(3) In (1) or (2) above, the (B) may have a molecular weight of 500 or more.
(4) In any one of (1) to (3) above, the melting point of the (B) may be 150° C. or higher.
(5) In any one of (1) to (4) above, the (B) may be included at a content of 0.05 parts by mass or more and 1.0 part by mass or less with respect to 100 parts by mass of the (A).
(6) In any one of (1) to (5) above, the (B) may be a phenolic antioxidant.
(7) In any one of (1) to (6) above, the (B) may be a hindered phenolic antioxidant.
(8) In any one of (1) to (7) above, the (A) may be a propylene-α-olefin block copolymer.
(9) A vehicle coolant transport tube according to an embodiment of the disclosure is composed of the resin composition for a vehicle coolant transport tube according to any one of (1) to (8) above.

The resin composition for a vehicle coolant transport tube according to an embodiment of the disclosure is obtained by blending an antioxidant having a high melting point with a polypropylene-based resin having a high melting point and a specific melt flow rate. Thus, high-temperature extrusion is possible, and flowability of the resin composition can be improved by high-temperature extrusion, and inner surface smoothness of a tube can become excellent. In addition, heat resistance is excellent. Thus, even if an extrusion temperature is increased, deterioration in physical properties is suppressed.

Herein, with the (B) being an antioxidant that does not have an ester bond in the molecular skeleton, thermal decomposition is less likely to occur, and heat resistance is more excellent. In addition, since an oxygen atom content decreases and polarity decreases, compatibility with the polypropylene-based resin increases, and inner surface smoothness of the tube is improved.

Also, with the molecular weight of the (B) being 500 or more, compatibility with the polypropylene-based resin, which is a polymer, is increased, and inner surface smoothness of the tube is improved.

Also, with the melting point of the (B) being 150° C. or higher, thermal decomposition is further less likely to occur, and heat resistance is more excellent.

Also, with the content of the (B) being 0.05 parts by mass or more and 1.0 part by mass or less with respect to 100 parts by mass of the (A), balance is excellent between physical properties and effect due to blending of (B).

Also, with the (B) being a phenolic antioxidant, heat resistance is more excellent. In addition, with the (B) being a hindered phenolic antioxidant, heat resistance is particularly excellent.

Also, with the (A) being a propylene-α-olefin block copolymer, physical properties are excellent.

Also, the vehicle coolant transport tube according to an embodiment of the disclosure is composed of the above resin composition for a vehicle coolant transport tube. Thus, high-temperature extrusion is possible, and heat resistance and inner surface smoothness are excellent.

### BRIEF DESCRIPTION OF THE DRAWING

FIGURE is a configuration view showing a vehicle coolant transport tube according to an embodiment of the disclosure.

### DESCRIPTION OF THE EMBODIMENTS

An embodiment of the disclosure provides a resin composition for a vehicle coolant transport tube and a vehicle coolant transport tube capable of high-temperature extrusion and excellent in heat resistance and inner surface smoothness.

A resin composition for a vehicle coolant transport tube and a vehicle coolant transport tube according to the disclosure will be described in detail.

The resin composition for a vehicle coolant transport tube according to the disclosure (which may be referred to as “present resin composition” hereinafter) contains (A) and (B) below.
(A) A polypropylene-based resin having a melting point of 145° C. or higher, and a melt flow rate (which may be referred to as “MFR” hereinafter) of 0.2 g/10 min or more and 2.0 g/10 min or less measured at 230° C. under a load of 2.16 kg
(B) An antioxidant having a melting point of 100° C. or higher

The present resin composition is obtained by blending an antioxidant having a high melting point with a polypropylene-based resin having a high melting point and a specific melt flow rate. Thus, high-temperature extrusion is possible, and flowability of the resin composition can be improved by high-temperature extrusion, and inner surface smoothness of a tube can become excellent. In addition, heat resistance is excellent. Thus, even if an extrusion temperature is increased, deterioration in physical properties is suppressed. High-temperature extrusion refers to performing extrusion in a temperature range of 260° C. to 280° C.

The polypropylene-based resin of (A) exhibits a specific MFR. If the MFR of the polypropylene-based resin of (A) exceeds 2.0 g/10 min, high-temperature physical properties cannot be ensured. In addition, heat resistance is inferior. In addition, high-temperature extrusion cannot be performed. If the MFR of the polypropylene-based resin of (A) is less than 0.2 g/10 min, flowability during extrusion cannot be ensured. With the MFR of the polypropylene-based resin of (A) being 0.2 g/10 min or more and 2.0 g/10 min or less, high-temperature physical properties, heat resistance, and flowability can be ensured, and high-temperature extrusion becomes possible. The MFR of the polypropylene-based resin of (A) is more preferably 0.3 g/10 min or more and 1.8 g/10 min or less, even more preferably 0.4 g/10 min or more and 1.6 g/10 min or less, and particularly preferably 0.5 g/10 min or more and 1.5 g/10 min or less. The MFR is measured in accordance with JIS K 7210:1999 under conditions of 230° C. and a load of 2.16 kg.

The polypropylene-based resin of (A) exhibits a specific melting point. If the melting point of the polypropylene-based resin of (A) is less than 145° C., high-temperature physical properties cannot be ensured. In addition, heat resistance is inferior. With the melting point of the polypropylene-based resin of (A) being 145° C. or higher, high-temperature physical properties and heat resistance can be ensured, and high-temperature extrusion becomes possible. The melting point of the polypropylene-based resin of (A) is more preferably 148° C. or higher, even more preferably 150° C. or higher, and particularly preferably 155° C. or higher. An upper limit value of the melting point of the polypropylene-based resin of (A) is not particularly limited, but is preferably 175° C. or lower, from the viewpoint of being capable of ensuring flowability during extrusion without an overly high viscosity. The melting point may be measured, for example, according to a method in accordance with JIS K7121-2012.

Examples of the polypropylene-based resin of (A) include propylene homopolymer, propylene-α-olefin random copolymer, propylene-α-olefin block copolymer, acid-modified products thereof, etc. The polypropylene-based resin of (A) may be composed of one type of the above alone or may be composed of two or more types. In the case where the polypropylene-based resin of (A) is composed of two or more types of the above, each component may be within the above ranges of the MFR and the melting point, or the entirety may be within the above ranges of the MFR and the melting point. Among the above, from the viewpoint of being excellent in physical properties and the like, propylene-α-olefin block copolymer is particularly preferable. The propylene-α-olefin block copolymer is a block copolymer having at least a block

composed of continuous propylene monomers and a block composed of continuous α-olefin monomers. The propylene-α-olefin block copolymer is not limited to the above, and may also be an alloy (mixture) having a sea-island structure in which a polypropylene component such as a propylene homopolymer is taken as a sea phase, and a polyethylene component and/or an ethylene-based rubber component is taken as an island phase. The propylene-α-olefin block copolymer is a concept that encompasses such an alloy.

Examples of the α-olefin include ethylene, 1-butene, 1-hexene, 4-methyl-1-pentene, 1-octene, etc. Specifically, ethylene, 1-butene, and 1-hexene are preferable, and ethylene is particularly preferable.

Examples of the polyethylene component include ethylene homopolymer, ethylene-based copolymer such as ethylene-vinyl acetate copolymer, ethylene-acrylic acid copolymer, ethylene-methacrylic acid copolymer, copolymer of ethylene and α-olefin (ethylene-propylene copolymer, ethylene-butene copolymer, ethylene-octene copolymer), etc. Examples of the ethylene-based rubber component include ethylene-propylene-diene terpolymer (EPDM), ethylene-propylene copolymer (EPR), ethylene-butene copolymer (EBR), ethylene-octene copolymer (EOR), etc. A content ratio of the polyethylene component and/or the ethylene-based rubber component with respect to the entire alloy (mixture) is preferably 1 to 49 mass %, and more preferably 2.5 to 20 mass %.

Examples of acid or a derivative thereof in the acid-modified product include unsaturated carboxylic acid and a derivative thereof. Examples of the unsaturated carboxylic acid include maleic acid, fumaric acid, acrylic acid, methacrylic acid, etc. Examples of the derivative of the unsaturated carboxylic acid include acid anhydride, ester compound, amide compound, imide compound, metal salt, etc. of the unsaturated carboxylic acid.

The antioxidant of (B) exhibits a specific melting point. If the melting point of the antioxidant of (B) is less than 100° C., heat resistance deteriorates. With the melting point of the antioxidant of (B) being 100° C., heat resistance can be ensured, and high-temperature extrusion becomes possible. From the viewpoint of improvement of heat resistance, improvement effect of inner surface smoothness of the tube by high-temperature extrusion, etc., the melting point of the antioxidant of (B) is preferably 150° C. or higher, more preferably 180° C. or higher, even more preferably 200° C. or higher, and particularly preferably 230° C. or higher. On the other hand, from the viewpoint of compatibility with the polypropylene-based resin of (A), heat resistance of the polypropylene-based resin of (A), etc., the melting point of the antioxidant of (B) is preferably 280° C. or lower, more preferably 270° C. or lower, and even more preferably 260° C. or lower. The melting point may be measured, for example, according to a method in accordance with JIS K7121-2012.

From the viewpoint of improving compatibility with the polypropylene-based resin of (A), improving inner surface smoothness of the tube, etc., a molecular weight of the antioxidant of (B) is preferably larger. The molecular weight of the antioxidant of (B) is preferably 500 or higher, more preferably 600 or higher, and even more preferably 700 or higher. Although an upper limit of the molecular weight of the antioxidant of (B) is not particularly limited, from the viewpoint of compatibility with the polypropylene-based resin of (A), heat resistance of the polypropylene-based resin of (A), etc., due to an increase in the melting point, the upper limit is preferably 1300 or lower, more preferably 1200 or lower, and even more preferably 1000 or lower.

From the viewpoint of ensuring physical properties of the polypropylene-based resin of (A), with respect to 100 parts by mass of the polypropylene-based resin of (A), a content of the antioxidant of (B) is preferably 1.0 part by mass or less, more preferably 0.8 parts by mass or less, and even more preferably 0.5 parts by mass or less. In addition, from the viewpoint of being excellent in blending effect of the antioxidant of (B), with respect to 100 parts by mass of the polypropylene-based resin of (A), the content of the antioxidant of (B) is preferably 0.05 parts by mass or more, more preferably 0.1 parts by mass or more, and even more preferably 0.2 parts by mass or more. If the content of the antioxidant of (B) is 0.05 parts by mass or more and 1.0 part by mass or less with respect to 100 parts by mass of the polypropylene-based resin of (A), balance is excellent between physical properties and effect due to blending of the antioxidant of (B).

Examples of the antioxidant of (B) may include a phenolic antioxidant, an amine-based antioxidant, an imidazole-based antioxidant, a phosphoric acid-based antioxidant, etc. The antioxidant of (B) may be composed of only one type of the above, or may be composed of two or more types. Among the above, from the viewpoint of being more excellent in heat resistance, the phenolic antioxidant is preferable. In addition, among phenolic antioxidants, a hindered phenolic antioxidant is particularly preferable, from the viewpoint of heat resistance.

Examples of the hindered phenolic antioxidant include 2,4,6-tris(4-hydroxy-3,5-di-tert-butylbenzyl) mesitylene (e.g., “IRGANOX 1330” manufactured by BASF, melting point 248 to 252° C., molecular weight 775), 4,4′,4″-(1-methylpropanyl-3-ylidene)tris(6-tert-butyl-m-cresol) (e.g., “AO-30” manufactured by ADEKA, melting point 183 to 185° C., molecular weight 545), 1,3,5-tris(3,5-di-tert-butyl-4-hydroxybenzyl) isocyanurate (e.g., “IRGANOX 3114” manufactured by BASF, melting point 220 to 222° C., molecular weight 784), N,N′-hexamethylenebis [3-(3,5-di-tert-butyl-4-hydroxyphenyl) propanamide] (e.g., “IRGANOX 1098” manufactured by BASF, melting point 156 to 161° C., molecular weight 637), pentaerythritol tetrakis [3-(3,5-di-tert-butyl-4-hydroxyphenyl) propionate] (e.g., “IRGANOX 1010” manufactured by BASF, melting point 110 to 125° C., molecular weight 1178), 1,6-hexanediol bis [3-(3,5-di-tert-butyl-4-hydroxyphenyl) propionate] (e.g., “IRGANOX 259” manufactured by BASF, melting point 104 to 108° C., molecular weight 639), etc.

The antioxidant of (B) preferably does not have an ester bond in the molecular skeleton. With an antioxidant without an ester bond in the molecular skeleton, thermal decomposition is less likely to occur, and heat resistance is more excellent. In addition, since an oxygen atom content decreases and polarity decreases, compatibility with the polypropylene-based resin of (A) increases, and inner surface smoothness of the tube is improved.

Examples of the hindered phenolic antioxidant without an ester bond in the molecular skeleton include 2,4,6-tris(4-hydroxy-3,5-di-tert-butylbenzyl) mesitylene (e.g., “IRGANOX 1330” manufactured by BASF, melting point 248 to 252° C., molecular weight 775), 4,4′,4″-(1-methylpropanyl-3-ylidene)tris(6-tert-butyl-m-cresol) (e.g., “AO-30” manufactured by ADEKA, melting point 183 to 185° C., molecular weight 545), 1,3,5-tris(3,5-di-tert-butyl-4-hydroxybenzyl) isocyanurate (e.g., “IRGANOX 3114” manufactured by BASF, melting point 220 to 222° C., molecular weight 784), etc.

The present resin composition takes the polypropylene-based resin of (A) as a main component. “Main component” means 50 mass % or more with respect to 100 mass % of the present resin composition. The main component is preferably 55 mass % or more and 99 mass % or less, more preferably 60 to 90 mass %, and even more preferably 65 to 80 mass %.

The present resin composition may contain another resin component other than (A) within a range that does not inhibit the effects of the disclosure. Examples of the another resin component include a polypropylene-based resin that is not included in (A). Examples of the other polypropylene-based resin include propylene homopolymer, propylene-α-olefin random copolymer, propylene-α-olefin block copolymer, acid-modified products thereof, etc. The above may be used as one type alone as the another resin component, or may be used as a combination of two or more types.

In addition, as the another resin component, a modified resin may be included together to cause (A) and a non-modified polypropylene-based resin, which is not included in (A), to be compatible with each other. Examples of such a modified resin include acid-modified or carboxy-modified polypropylene-based resin. A content of the modified resin is not particularly limited, but is 0.5 to 10 parts by mass, and preferably 0.5 to 5 parts by mass, with respect to 100 parts by mass of the polypropylene-based resin.

The present resin composition may contain another component in addition to (A) and (B) within a range that does not inhibit the effects of the disclosure. Examples of the another component include a filler, a weathering stabilizer, a lubricant, a pigment, a dye, an antistatic agent, a plasticizer, a reinforcing agent, etc.

Examples of the filler include an inorganic filler such as talc, silica, mica, kaolin, calcium carbonate, potassium titanate, apatite, mica, etc. The above may be used alone or as a combination of two or more types. Specifically, talc is preferable from the viewpoint of extrusion processability, reinforcement properties, etc.

A content of the filler is not particularly limited, but from the viewpoint of strength, is 1 to 100 parts by mass, and preferably 10 to 70 parts by mass, with respect to 100 parts by mass of the polypropylene-based resin.

According to the present resin composition with the above configuration, since an antioxidant having a high melting point is blended with a polypropylene-based resin having a high melting point and a specific melt flow rate, high-temperature extrusion is possible, flowability of the resin composition can be improved by high-temperature extrusion, and inner surface smoothness of the tube can become excellent. In addition, heat resistance is excellent. Thus, even if the extrusion temperature is increased, deterioration in physical properties is suppressed.

The vehicle coolant transport tube according to the disclosure (which may be referred to as “present resin tube” hereinafter) may be obtained from the present resin composition. The present resin tube is suitably implemented as a resin tube 10 of a one-layer structure as shown in FIGURE, for example. In addition, wherever necessary, other resin layers or reinforcing fiber layers may be further laminated to configure as a resin tube of a multi-layer structure.

From the viewpoint of applications thereof, the present resin tube preferably has an inner diameter in a range of 2.5 to 30 mm, particularly 4 to 25 mm, and a thickness in a range of 0.5 to 5.0 mm, particularly 0.75 to 4.0 mm.

The present resin tube is used, for example, for a piping of a coolant in an automobile, and specifically, is suitably used for a radiator hose, a heater hose, an air conditioner hose, etc., or for a cooling tube of a battery pack for an electric vehicle or a fuel cell vehicle.

The present resin tube may be manufactured by melt extrusion molding of the present resin composition into a tubular shape. The present resin composition may be obtained by blending and kneading (A), (B), and a component to be blended wherever necessary.

A kneading process of the present resin composition is preferably performed using, for example, a twin-screw kneading extruder. A kneading temperature is preferably 190° C. to 230° C. A kneading time is preferably 0.01 to 10 minutes.

An extrusion process of the present resin composition is preferably performed using, for example, a twin-screw kneading extruder. From the viewpoint of improving inner surface smoothness of the tube by high-temperature extrusion, an extrusion temperature is preferably 260° C. to 280° C.

Although the embodiment of the disclosure has been described above, the disclosure is not limited to the above embodiment in any manner, and various modifications are possible within a scope that does not deviate from the gist of the disclosure.

### EXAMPLES

Hereinafter, the disclosure will be described in detail based on Examples and Comparative Examples.

### Examples 1 to 4, Comparative Examples 1 to 3

Each component was blended in the blending ratio (parts by mass) shown in the table, and kneaded for 5 minutes at 200° C. using a twin-screw kneading extruder (“TEM-18SS” manufactured by Toshiba Machine) to obtain a kneaded material. Next, the kneaded material was pelletized, and the pellets were melt extrusion molded into a tubular shape at 270° C. using a melt extrusion molding machine (“GT-40” manufactured by Research Laboratory of Plastics Technology Co., Ltd.) equipped with a cylindrical die to obtain a resin tube with an inner diameter of 18 mm and an outer diameter of 20 mm.

The materials used are as follows.

### (a) Polypropylene-Based Resin

Polypropylene-based resin <1>: Propylene-α-olefin block copolymer, “E-702 MG” manufactured by Prime Polymer, MFR 1.4 g/10 min, melting point 162° C.
Polypropylene-based resin <2>: Propylene-α-olefin block copolymer, “E-701G” manufactured by Prime Polymer, MFR 0.5 g/10 min, melting point 163° C.

### (A′) Polypropylene-Based Resin

Polypropylene-based resin <3>: Propylene homopolymer, “J106MG” manufactured by Prime Polymer, MFR 16 g/10 min, melting point 160° C.

### (B) Antioxidant

Antioxidant <1>: Phenolic antioxidant, “IRGANOX1330” manufactured by BASF, melting point 248 to 252° C., molecular weight 775, number of ester bonds 0
Antioxidant <2>: Phenolic antioxidant, “AO-30” manufactured by ADEKA, melting point 183 to 185° C., molecular weight 545, number of ester bonds 0
Antioxidant <3>: Phenolic antioxidant, “IRGANOX3144” manufactured by BASF, melting point 220 to 222° C., molecular weight 784, number of ester bonds 0

### (B′) Antioxidant

Antioxidant <4>: Phenolic antioxidant, “IRGANOX1035” manufactured by BASF, melting point 63 to 78° C., molecular weight 643, number of ester bonds 2
Antioxidant <5>: “IRGANOX1076” manufactured by BASF, phenolic antioxidant, melting point 50 to 55° C., molecular weight 531, number of ester bonds 1

For each obtained resin tube, evaluations on properties were performed according to the following criteria. The results are also shown in Table 1 below.

### <Cross-Section Foaming>

The obtained resin tube was cut in half, and those without visible voids were rated as “∘ (good)”, and those with visible voids were rated as “x (poor)”.

### <Smoothness (High-Temperature Extrusion)>

The obtained resin tube was cut in half, and measurements were performed with calipers at three spots including a center part and vicinities of left and right cross-sections. Compared to a target thickness (1.00 mm), those with any of the three spots deviating by 0.03 mm or more were rated as “x (poor)”, and those with all three spots deviating by less than 0.03 mm were rated as “∘ (good)”.

### <Heat Resistance>

After a heat treatment at 160° C. for 1 hour, the resin tube was cut in half and punched into a strip shape with a width of 10 mm and a length of 15 cm. After implementing a thermal aging treatment (heat treatment at 130° C. for 500 hours, heat treatment at 130° C. for 750 hours) on the obtained strip-shaped sample, an elongation at break [Eb] was measured in accordance with JIS K 6251 using a tensile testing machine (AGS-X, manufactured by Shimadzu Corporation). Those with an elongation at break of 200% or more after 750 hours were rated as “⊚ (very good)”, those with an elongation at break of 200% or more after 500 hours were rated as “∘ (good)”, and those with an elongation at break of less than 200% after 500 hours were rated as “x (poor)”.

TABLE 1

| | | Melting | | Number | | | | | | | |
|---|---|---|---|---|---|---|---|---|---|---|---|
| | | point | Molecular | of ester | Example | | | | Comparative Example | | |
| | | (° C.) | weight | bonds | 1 | 2 | 3 | 4 | 1 | 2 | 3 |
| (A) | Polypropylene-based | | | | 100 | 100 | 100 | — | 100 | 100 | — |
| | resin <1> (MFR 1.4) | | | | | | | | | | |
| | Polypropylene-based | | | | — | — | — | 100 | — | — | — |
| | resin <2> (MFR 0.5) | | | | | | | | | | |
| (A′) | Polypropylene-based | | | | — | — | — | — | — | — | 100 |
| | resin <3> (MFR 16) | | | | | | | | | | |
| (B) | Antioxidant <1> | 248-252 | 775 | 0 | 0.3 | — | — | 0.3 | — | — | 0.3 |
| | Antioxidant <2> | 183-185 | 545 | 0 | — | 0.3 | — | — | — | — | — |
| | Antioxidant <3> | 220-222 | 784 | 0 | — | — | 0.3 | — | — | — | — |
| (B′) | Antioxidant <4> | 63-78 | 643 | 2 | — | — | — | — | 0.3 | — | — |
| | Antioxidant <5> | 50-55 | 531 | 1 | — | — | — | — | — | 0.3 | — |

| | | | | | | | | |
|---|---|---|---|---|---|---|---|---|
| Evaluation | Cross-section foaming | ◯ | ◯ | ◯ | ◯ | ◯ | X | ◯ |
| | Smoothness (high-temperature extrusion) | ◯ | ◯ | ◯ | ◯ | X | — | ◯ |
| | Center part (mm) | 0.99 | 1.02 | 1.01 | 1.00 | 1.02 | — | 1.04 |
| | Right end part (mm) | 1.01 | 1.02 | 1.02 | 1.01 | 1.04 | — | 1.02 |
| | Left end part (mm) | 1.00 | 0.99 | 0.98 | 0.98 | 0.97 | — | 0.96 |
| | Heat resistance | ⊚ | ◯ | ◯ | ◯ | X | — | X |
| | 500 H (%) | 270 | 250 | 280 | 300 | 90 | — | 180 |
| | 750 H (%) | 230 | 170 | 190 | 270 | — | — | — |

Comparative Examples 1 to 2 use antioxidants with melting points below 100° C. In Comparative Example 1, smoothness of the tube inner surface has not been improved. In addition, heat resistance is poor. In Comparative Example 2, a foaming phenomenon has occurred due to high-temperature extrusion, and high-temperature extrusion has not been possible. Comparative Example 3 uses a polypropylene-based resin with an MFR exceeding 2.0 g/10 min. In Comparative Example 3, heat resistance is poor.

In contrast, in Examples, no foaming phenomenon has occurred even with high-temperature extrusion. In addition, heat resistance is excellent, and deterioration in physical properties has been suppressed even if the extrusion temperature is increased. Thus, high-temperature extrusion is possible. In addition, flowability of the resin composition has been improved due to high-temperature extrusion, and inner surface smoothness of the tube is excellent. From the above, it has been confirmed that high-temperature extrusion is possible, and heat resistance and inner surface smoothness are excellent by configuring a resin composition containing: (A) a polypropylene-based resin having a melting point of 145° C. or higher and a melt flow rate of 0.2 g/10 min or more and 2.0 g/10 min or less measured at 230° C. under a load of 2.16 kg; and (B) an antioxidant having a melting point of 100° C. or higher.

Although the embodiment and Examples of the disclosure have been described above, the disclosure is not limited to the above embodiment and Examples in any manner, and various modifications are possible within a scope that does not deviate from the gist of the disclosure.

1. A resin composition for a vehicle coolant transport tube, comprising (A) and (B) below:
(A) a polypropylene-based resin having a melting point of 145° C. or higher and a melt flow rate of 0.2 g/10 min or more and 2.0 g/10 min or less measured at 230° C. under a load of 2.16 kg; and
(B) an antioxidant having a melting point of 100° C. or higher.

2. The resin composition for a vehicle coolant transport tube according to claim 1, wherein the (B) is an antioxidant that does not have an ester bond in a molecular skeleton.

3. The resin composition for a vehicle coolant transport tube according to claim 1, wherein the (B) has a molecular weight of 500 or more.

4. The resin composition for a vehicle coolant transport tube according to claim 1, wherein the melting point of the (B) is 150° C. or higher.

5. The resin composition for a vehicle coolant transport tube according to claim 1, wherein the (B) is included at a content of 0.05 parts by mass or more and 1.0 part by mass or less with respect to 100 parts by mass of the (A).

6. The resin composition for a vehicle coolant transport tube according to claim 1, wherein the (B) is a phenolic antioxidant.

7. The resin composition for a vehicle coolant transport tube according to claim 1, wherein the (B) is a hindered phenolic antioxidant.

8. The resin composition for a vehicle coolant transport tube according to claim 1, wherein the (A) is a propylene-α-olefin block copolymer.

9. A vehicle coolant transport tube composed of the resin composition for a vehicle coolant transport tube according to claim 1.
